(19) United States
(12) Patent Application Publication
(10) Pub. No.: US 2013/0034092 A1
(43) Pub. Date: Feb. 7, 2013

(54) Joint Channel Detection of Out of Synchronization Condition

(71) Applicants: Karl Marko Juhani Lampinen, Oulu (FI); Arto Lehti, Oulu (FI)

(72) Inventors: Karl Marko Juhani Lampinen, Oulu (FI); Arto Lehti, Oulu (FI)

(73) Assignee: Renesas Mobile Corporation

(21) Appl. No.: 13/204,073

(22) Filed: Aug. 5, 2011

(51) Int. Cl. H04W 56/00

(52) U.S. Cl. 370/350

(57) ABSTRACT

To test whether a first radio channel is synchronized, a first quality value (e.g., power control bits) is determined for a first radio channel (e.g., DPCCH or F-DPCH), and a second quality value is determined for a second radio channel (e.g., PCICH) which carries precoding information (e.g., beamforming weights); then the first and second quality values are combined. In specific embodiments the combining includes comparing the first and second quality values against respective first and second thresholds to obtain respective first and second binary results that are logically combined; or by multiplying the first and second quality values by respective first and second weighting values to achieve weighted values which are added.

### TECHNICAL FIELD

The exemplary and non-limiting embodiments of this invention relate generally to wireless communication systems, methods, devices and computer programs, and more specifically relate to testing synchronization of a radio channel.

### BACKGROUND

The following abbreviations used in the specification and/or the drawings are defined as follows:

3 GPP third generation partnership project

DL downlink (network towards UE)

DPCCH dedicated physical control channel

DPDCH dedicated physical data channel

NodeB base station of a UTRAN system

F-DPCH fractional dedicated physical channel

PCI precoding information

PCICH precoding information channel

PDCCH physical downlink control channel

RNC radio network controller

SINR signal to interference plus noise ratio

TPC transmit power control

UE user equipment

UL uplink (UE towards network)

UTRAN universal terrestrial radio access network (3G)

Any radio systems require a certain level of synchronization between the network and the portable devices which access it. Synchronization tolerances are quite stringent for most radio systems, particularly cellular systems which are designed for highly efficient use of the radio spectrum. The UTRAN system uses the DPDCH for downlink data and the DPCCH for downlink control signaling. There is also a F-DPCH which is a special case of the DPCCH and for which is defined a TPC field in which is placed TPC bits that the network sets to signal the recipient user device (generally termed a UE) changes to the UE's transmit power. The term UTRAN refers to a number of different 3G systems, (including but not limited to): global system for mobile communication GSM; enhanced data rates for GSM evolution EDGE; high speed packet access HSPA; and wideband code division multiple access WCDMA.

A UE having a radio connection with a network will typically test its synchronization routinely to assure its timing relative to that of the network has not shifted beyond allowable tolerances. When first establishing a connection with the network the UE also has to test that proper synchronization has been acquired. Synchronization of the DPDCH, the DPCCH, and the F-DPCH is monitored by the DPCCH or TPC bit quality. Specifically, the quality monitoring procedure is described at section 4.2 of 3GPP TS 25.214 V10.1.0 (2011-03), and the related performance test is detailed at section 6.4.4 et seq. of 3GPP TS 25.101 V10.2.0 (2011-06). If an existing connection is falling out of synchronization or if synchronization is achieved on a new connection, the UE is specified to indicate to higher layers a synchronization status change using the physical layer control message in-synchronization indicator (CPHY-Sync-IND) and out-of-synchronization indicator (CPHY-Out-of-Sync-IND) primitives as described in TS 25.214 referenced above.

The exemplary embodiments of the invention as detailed below provide a more effective manner to test channel synchronization.

### SUMMARY

In a first exemplary embodiment of the invention there is an apparatus comprising a processing system comprising at least one processor, and a memory storing a set of computer instructions. In this exemplary embodiment the processing system is arranged to: determine a first quality value for a first radio channel and a second quality value for a second radio channel, in which the second radio channel carries precoding information; and test whether the first radio channel is synchronized by combining the first quality value with the second quality value.

In a second exemplary embodiment of the invention there is a method comprising: determining a first quality value for a first radio channel and a second quality value for a second radio channel, in which the second radio channel carries precoding information; and testing whether the first radio channel is synchronized by combining the first quality value with the second quality value.

In a third exemplary embodiment of the invention there is a computer readable memory storing a computer program, in which the computer program comprises: code for determining a first quality value for a first radio channel and a second quality value for a second radio channel, in which the second radio channel carries precoding information; and code for testing whether the first radio channel is synchronized by combining the first quality value with the second quality value.

These and other embodiments and aspects are detailed below with particularity.

### BRIEF DESCRIPTION OF THE DRAWINGS

FIG. 1 is a schematic diagram illustrating functional blocks for hard-combining signal quality estimates from two channels to test synchronization according to a first exemplary embodiment of these teachings.

FIG. 2 is similar to FIG. 1 but for soft-combining according to a second exemplary embodiment of these teachings.

FIG. 3 is a logic flow diagram that illustrates the operation of a method, and a result of execution of computer program instructions embodied on a computer readable memory, in accordance with the exemplary embodiments of this invention.

FIG. 4 is a simplified block diagram of various network devices and a UE which may include the circuitry shown at FIGS. 1-2, which are exemplary electronic devices suitable for use in practicing the exemplary embodiments of the invention.

### DETAILED DESCRIPTION

For the HSPA flavor of UTRAN a work item has been recently initiated to introduce beamforming weights (termed precoding information or PCI) sent downlink to support uplink transmit diversity. See for example proposal 3 at page 19 of the Draft Report of 3GPP TSG RAN WG1 #65 v0.1.0 (9-13 May, 2011; Princesa Sofia Hotel, Barcelona, Spain) which tends to indicate that a channel similar to the F-DPCH will be used to carry possibly one or two bits of PCI which is/are to be channel encoded similarly as the TPC bit.

Document R1-111752 by Ericsson and ST-Ericsson entitled On the quality of PCI feedback in CLTD (3GPP TSG RAN WG1 Meeting #65; Barcelona, Spain, 9-13 May, 2011) suggests that the quality of this/these new PCI bits should also be monitored, the purpose being that the UE would apply the precoding weights it receives only if this monitoring proves the PCI bits are sufficiently reliable. This document also suggests that there should be additional PCI quality signaling in the UL physical layer using a TPC bit field in the S-DPCCH. The inventors do not consider that such UL signaling would be very reliable at least for those times the UE's monitoring found the PCI bits too unreliable to put into use. The exemplary embodiments of the invention detailed below put those PCI bits to a different use than is set forth at document R1-111752, namely for use in testing the UE's synchronization to the network. This method has the advantage of providing the reliability of the PCI bits without the additional signaling.

While the exemplary embodiments of the invention detailed below are in the context of the PCI bits of the PCICH and the TPC bits of the DPCCH which are UTRAN-specific terms, these are simply examples and not limiting to the broader teachings herein. Various other systems name antenna weights and power control bits differently. Similarly, the PCICH and the DPCCH are logical channels and so may be named differently in non-UTRAN systems. Regardless, the same principles detailed herein can also be used for those differently named parameters and channels in other wireless systems utilizing radio access technologies different from UTRAN. Such other systems are not limited to only cellular-type systems but also apply for wireless local area networks and other non-cellular radio access technologies since synchronization is an important part of nearly all modem wireless communications.

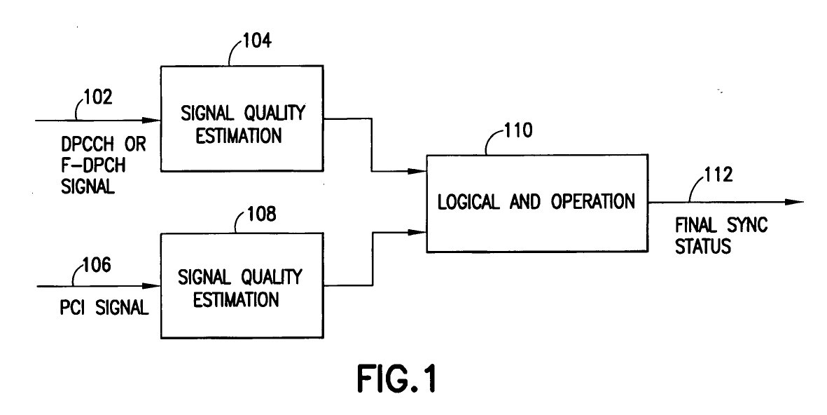

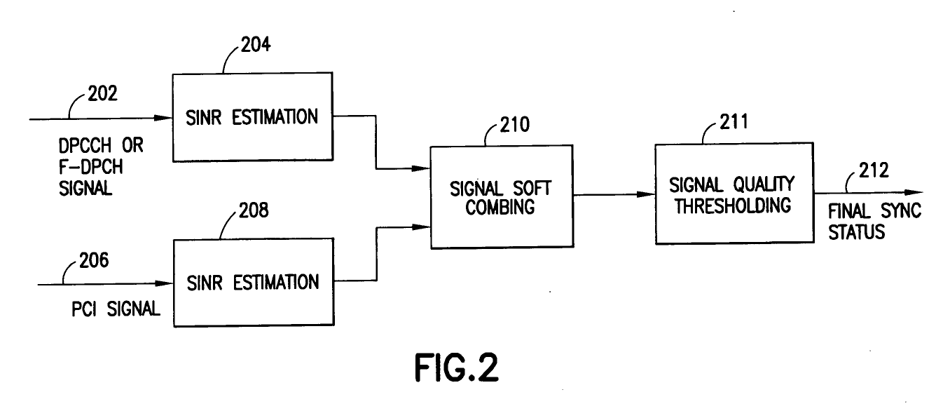

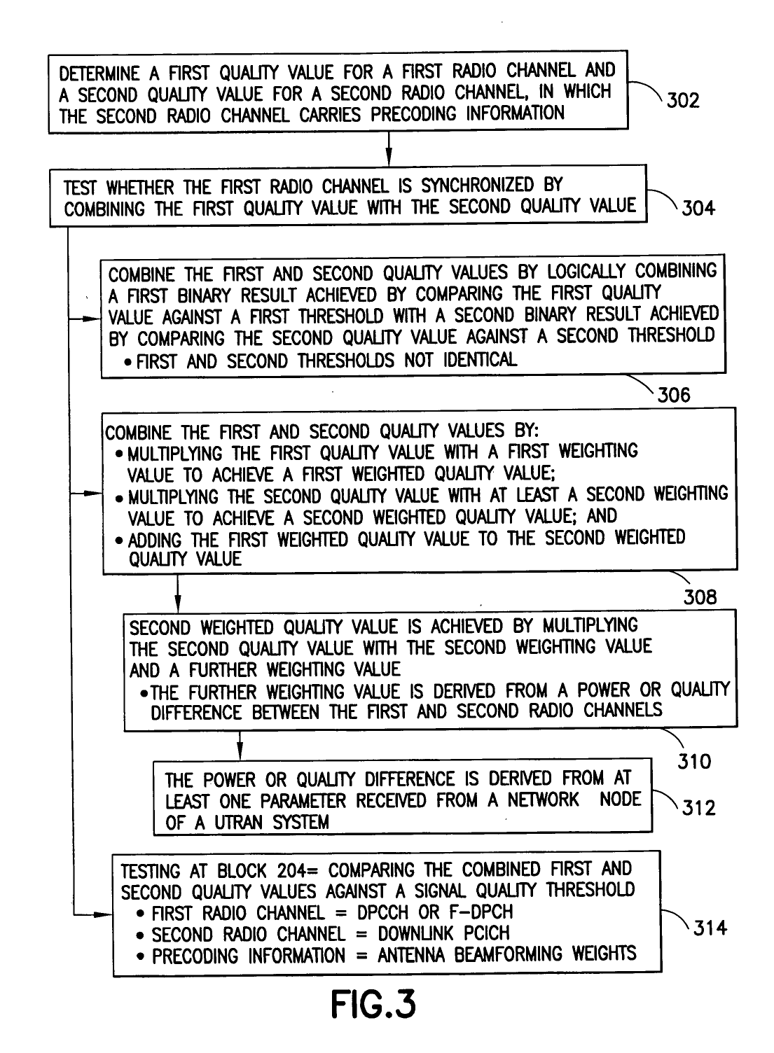

Exemplary embodiments of the invention are described below with reference to FIG. 3 which is from the perspective of the UE (or one of more components thereof). Certain of the non-limiting embodiments are also detailed with reference to FIGS. 1 and 2.

The first two blocks of FIG. 3 describe an embodiment of the invention in broad terms. First at block 302 there is determined a first quality value for a first radio channel and a second quality value for a second radio channel. In this case the second radio channel carries precoding information. Once those quality values are determined, then at block 304 the UE tests whether the first radio channel is synchronized, and it does this testing by combining the first quality value with the second quality value. Various different types of combining are detailed in the more specific embodiments below.

Block 314 relates the terms of blocks 302 and 304 to the bit fields and logical channels noted above for a UTRAN-specific implementation: the first channel is a DPCCH or a F-DPCH and the first quality value is for power control bits received on the DPCCH or a F-DPCH; while the second channel is a DL PCICH and the second quality value is for the precoding information PCI (e.g., beamforming weight or weights) received on that PCICH.

Below are various exemplary embodiments for how the combining of block 304 might be implemented. In a first exemplary embodiment the quality information is hard-combined: a logical operation (for example a logical AND, NAND, OR and/or similar) is used to decide whether both channels (or the information fields on those two channels) have achieved synchronization. In the case of an AND or NAND operator the testing at block 304 yields a single result which is valid for both the first and second channels. This hard combining embodiment is particularly useful if this is how the UTRAN or other technology specifies that the PCI quality should be taken into account for testing/monitoring the status of the overall synchronization.

For example, if the controlling radio specifications mandate or make optional that both the DPCCH (or F-DPCH which is a special case of the DPCCH) and the PCICH should be taken into account while evaluating the UE's synchronization status, the hard combining of the per channel synchronization status can be accomplished by the functional blocks shown at FIG. 1. In this hard combining implementation the signal quality is estimated separately, for the received DPCCH/F-DPCH 102 at block 104 and for the received PCICH 106 at block 108. The quality estimation can be based on SINR-thresholds for example, so that if the SINR is above some predefined threshold the quality target is achieved for that channel. Such a SINR check is seen at U.S. Pat. No. 7,149,538 for example. The output of each of the quality estimation blocks 104 and 108 is then a binary decision based on that comparison against the threshold: yes/no or 1/0 or synchronized/non-synchronized per channel. These two outputs can then be combined such as by a simple AND or other logical operation at block 110. The singular output of the logical combiner block 110 then reflects synchronization only if both channels are deemed via blocks 104 and 108 to have achieved the targeted/threshold quality level. This hard combining embodiment has the advantage that different target levels can be set for the two channels. In a practical UTRAN implementation at least, it is expected that the error level on the PCICH needs to be lower (for example, about 2%) than what is tolerated in the TPC bits of the DPCCH/F-DPCH channel (for example, about 20%).

This hard-combining first embodiment is summarized at block 306 of FIG. 3: the combining mentioned at block 304 is implemented in block 306 by a) obtaining a first binary result by comparing the first quality value against a first threshold (block 104 of FIG. 1); b) obtaining a second binary result by comparing the second quality value against a second threshold (block 108 of FIG. 1); and c) logically combining the first binary with the second binary result (block 110 of FIG. 1). Optionally block 306 of FIG. 3 also recites the different thresholds employed at blocks 104 and 108 of FIG. 1.

In a second exemplary embodiment the quality information is soft-combined. In these implementations there is soft information, such as for example SINR, on the quality of the two channels/fields which is combined. An advantage of this implementation is that it can take into account different quality target differences for those two channels. This soft combining embodiment is particularly useful if the target SINR differences between the channels are known and the PCI bits are used mainly to increase the reliability of the synchronization status reports.

FIG. 2 illustrates functional circuitry for implementing the soft-combining of the information from both channels according to this second embodiment, which can improve the quality of the conventional UTRAN quality estimation. This second embodiment can be made mandatory if the controlling radio specification links together the qualities of the PCICH and the DPCCH/F-DPCH. As one example of such a linking, a known or signaled power offset could be applied between the relevant channels and both channels could follow the same power control commands.

In the FIG. 2 implementation, from the received DPCCH or F-DPCH signal 202 is extracted the TPC bits and estimator block 204 estimates the SINR on them. Similarly, from the received PCICH signal 206 is extracted the PCI bit(s) and estimator block 208 estimates the SINR on it/them. The two SINRs are soft-combined at combiner block 210 as variously detailed below, and the combined result is compared against a signal quality threshold at 211 as stated at the top of block 314 of FIG. 3. The final synchronization status of the combined channels is then output 212 at FIG. 2, and if that output indicates there is a change to the UE's synchronization status then the UE reports as appropriate (in-synch, out-of-synch) to the network using the primitives noted above.

As an example of the soft combining done at combiner block 210 of FIG. 2, represent the measured SINR of the DPCCH/F-DPCH channel as μ_{TPC}, and the measured SINR of the PCICH channel as μ_{PCI}. These are the respective outputs of estimator blocks 204 and 208 of FIG. 2. Then the weighted average SINR μ=w₁μ_{TPC}+w₂μ_{PCI}, where w₁ and w₂ are the weighting values. In the averaging process these can be made equal for equal weighting: w₁=w₂=0.5 for example. Or the weighting values w₁ and w₂ can be implemented such that the channel with the more reliable estimate gets a higher weighting value.

This implementation of the second embodiment is shown at block 308 of FIG. 3. The combining of block 304 is implemented by a) multiplying the first quality value (μ_{TPC}) with a first weighting value (w₁) to achieve a first weighted quality value (w₁μ_{TPC}); b) multiplying the second quality value (μ_{PCI}) with at least a second weighting value (w₂) to achieve a second weighted quality value (w₂μ_{PCI}); and c) adding the first weighted quality value to the second weighted quality value to get the sum (μ).

Block 310 of FIG. 3 expands that ‘at least a second weighting value” of block 310 to add a further weighting value. In this case the weighted average SINR μ=w₁μ_{TPC}+w₂Δ_{PCI}μ_{PCI}, where the further weighting value Δ_{PCI} can be implemented as either the transmission power offset Δ_{P} or the target quality difference Δ_{Q}. The Δ_{P} equals the transmission power offset of the two channels whereas the target quality difference Δ_{Q} can be derived from the SINR difference expected by the quality target difference of the two channels. In either case, the transmission power offset Δ_{P} or the target quality difference Δ_{Q} is derived from one or more parameters which the network sends to the UE as provided at block 312 of FIG. 3. In the case of transmission power offset the UTRAN network signals the parameter Δ_{P} directly. In the case of target quality difference the UTRAN network can signal the parameter Δ_{Q} directly or it can signal the parameters P_{b, PCI} and P_{b, TPC}, which are target error rates for the respective PCI on the PCICH and the TPC on the DPCCH, from which the UE can derive the target quality difference Δ_{Q}. In one implementation of this second embodiment the network signals all the parameters needed for the UE to obtain Δ_{P} and Δ_{Q}, and the UE calculates the average Δ_{P} and ignores Δ_{Q}.

In an embodiment in which the UE does use the Δ_{Q}, if the network signals the parameters P_{b, PCI} and P_{b, TPC}, the UE can extract the target quality difference Δ_{Q} from a bit error rate curve of a BPSK signal. Such a bit error curve may be stored in the UE's local memory in various foul's; as an equation, as a lookup table, etc. By knowing both target error rates P_{b, PCI} and P_{b, TPC} the UE can enter the curve or lookup table and calculate the difference. For example it is known that the bit error probability of a BPSK signal P_{b}=Q(sqrt(2μ)). Therefore embodiments of these teachings can solve the SINR difference from the equation pair: P_{b, TPC}=Q(sqrt(2μ_{TPC})) and P_{b, PCI}=Q(sqrt(2μ_{PCI})).

As noted above for block 308, the weighting values w₁ and w₂ in the averaging process of block 310 can also be made equal for equal weighting or can vary to over-weight the more reliable quality value.

Note that averaging is used between the TPC and PCI bit information instead of other combining techniques used in signal processing such as for example maximal ratio combining MRC combining This is because the information itself from which the SINRs are obtained is different in kind, and so cannot be combined together as in conventional reception and still yield a valid result.

There is also a third embodiment in which there is no combining as in block 304. In truth this is a fallback condition for the case in which the PCI is not available to the UE to use in its combining. Occasions may arise in which the PCI based reporting needs to be temporarily disabled/turned off. Such a case may arise for example where the closed loop transmit diversity is turned off, meaning there is no PCI the network needs to send DL. In this case there is no combining in block 304 and the testing is done using only the DPCCH/F-DPCH information. Since one can reasonably assume that PCI was available prior to the PCI based reporting being turned off (or will be available again once the PCI-based reporting is turned back on), then the first or second exemplary embodiments noted above may be considered a first instance of a UE testing for synchronization and the no combining of this third embodiment may be considered a second instance of that same UE testing for synchronization. In this case first and second instance are not necessarily chronological but merely used to distinguish the two instances from one another.

FIG. 3 detailed above is a logic flow diagram which describes the above exemplary embodiments of the invention from the perspective of the UE 10. FIG. 3 represents results from executing a computer program or an implementing algorithm stored in the local memory of the UE 10, as well as illustrating the operation of a method and a specific manner in which the processor and memory with computer program/algorithm are configured to cause that UE 10 (or one or more components thereof) to operate. The various blocks shown in FIG. 3 may also be considered as a plurality of coupled logic circuit elements constructed to carry out the associated function(s), or specific result or function of strings of computer program code stored in a computer readable memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

In various embodiments the apparatus executing the process described at FIG. 3 may be the UE 10 as described, or one or more components thereof such as for example a wireless modem configured for use in a UE 10.

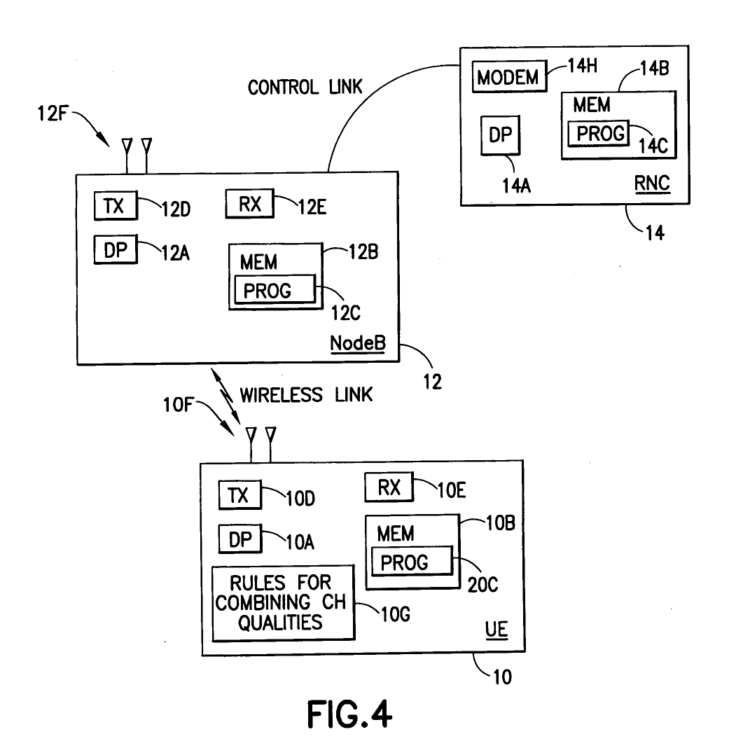

Reference is now made to FIG. 4 for illustrating a simplified block diagram of various electronic devices and apparatus that are suitable for use in practicing the exemplary embodiments of this invention. In FIG. 4 a serving cell/network access node 12 is adapted for communication over a wireless link with a mobile apparatus, such as a mobile terminal or UE 10. The network access node 12 may be a NodeB as identified at FIG. 4, an eNodeB (of an E-UTRAN system), an access point AP, a remote radio head or relay station, or other type of base station/cellular access node.

The UE 10 includes processing means such as at least one data processor (DP) 10A, storing means such as at least one computer-readable memory (MEM) 10B storing at least one computer program (PROG) 1 OC, and also communicating means such as a transmitter TX 10D and a receiver RX 10E for bidirectional wireless communications with the network access node 12 via one or more antennas 10F. The UE 10 stores at block 10G the rules for combining the different channel qualities, such as for example according to one or more of the exemplary embodiments and implementations that are detailed above.

The network access node 12 similarly includes processing means such as at least one data processor (DP) 12A, storing means such as at least one computer-readable memory (MEM) 12B storing at least one computer program (PROG) 12C, and communicating means such as a transmitter TX 12D and a receiver RX 12E for bidirectional wireless communications with the UE 10 via one or more antennas 12F. There is a data and/or control path, termed at FIG. 4 as a control link, coupling the network access node 12 with a radio network controller RNC 14. The RNC 14 represents any other higher network node or serving gateway providing connectivity to a broader network (a publicly switched telephone network or the Internet for example), and some systems may not have such a higher network node between the access node 12 and the Internet.

Similarly, the RNC 14 includes processing means such as at least one data processor (DP) 14A, storing means such as at least one computer-readable memory (MEM) 14B storing at least one computer program (PROG) 14C, and communicating means such as a modem 14H for bidirectional communication with the network access node 12 via the control link. While not particularly illustrated for the UE 10 or network access node 12, those devices are also assumed to include as part of their wireless communicating means a modem which may be inbuilt on a radiofrequency RF front end chip within those devices 10, 12 and which chip also carries the TX 10D/12D and the RX 10E/12E.

At least one of the PROGs 10C in the UE 10 is assumed to include program instructions that, when executed by the associated DP 10A, enable the device to operate in accordance with the exemplary embodiments of this invention, as detailed above. The network access node 12 and the RNC 14 also have software stored in their respective MEMs to implement certain aspects of these teachings. In these regards the exemplary embodiments of this invention may be implemented at least in part by computer software stored on the MEM 10B, 12B, 14B which is executable by the DP 10A of the UE 10 and/or by the DP 12A/14A of the respective network access node 12 and the RNC 14, or by hardware, or by a combination of tangibly stored software and hardware (and tangibly stored firmware). Electronic devices implementing these aspects of the invention need not be the entire devices as depicted at FIG. 4, but exemplary embodiments may be implemented by one or more components of same such as the above described tangibly stored software, hardware, firmware and DP, or a system on a chip SOC or an application specific integrated circuit ASIC.

Various embodiments of the computer readable MEMs 10B, 12B and 14B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 10A, 12A and 14A include but are not limited to general purpose computers, special purpose computers, microprocessors, digital signal processors (DSPs) and multi-core processors.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus, comprising:
a processing system comprising at least one processor, and a memory storing a set of computer instructions, in which the processing system is arranged to:
determine a first quality value for a first radio channel and a second quality value for a second radio channel, in which the second radio channel carries precoding information; and
test whether the first radio channel is synchronized by combining the first quality value with the second quality value.

2. The apparatus according to claim 1, in which the processing system is arranged to combine the first quality value with the second quality value by:
obtaining a first binary result by comparing the first quality value against a first threshold;
obtaining a second binary result by comparing the second quality value against a second threshold; and
logically combining the first binary with the second binary result.

3. The apparatus according to claim 2, in which the first threshold is not identical to the second threshold.

4. The apparatus according to claim 1, in which the processing system is arranged to combine the first quality value with the second quality value by:
multiplying the first quality value with a first weighting value to achieve a first weighted quality value;
multiplying the second quality value with at least a second weighting value to achieve a second weighted quality value; and
adding the first weighted quality value to the second weighted quality value.

5. The apparatus according to claim 4, in which the second weighted quality value is achieved by multiplying the second quality value with the second weighting value and a further weighting value, in which the further weighting value is derived from one of a power difference between the first and second radio channels and a quality difference between the first and second radio channels.

6. The apparatus according to claim 5, in which the apparatus comprises a user equipment operating in a UTRAN system, and the said one of power difference or quality difference is derived from at least one parameter received at the user equipment from a network node of the UTRAN system.

7. The apparatus according to claim 1, in which the processing system is arranged to test whether the first radio channel is synchronized by comparing the combined first and second quality values against a signal quality threshold;
in which the first quality value is for power control bits received on the first channel which is a DPCCH or a F-DPCH, the second quality value is for the precoding information received on the second channel which is a downlink PCICH, and the precoding information represents antenna beamforming weights.

8. The apparatus according to claim 7, in which the processing system is further arranged to send an indication of a change in synchronization status based on the test.

9. A method, comprising:
determining a first quality value for a first radio channel and a second quality value for a second radio channel, in which the second radio channel carries precoding information; and
testing whether the first radio channel is synchronized by combining the first quality value with the second quality value.

10. The method according to claim 9, in which combining the first quality value with the second quality value comprises:
obtaining a first binary result by comparing the first quality value against a first threshold;
obtaining a second binary result by comparing the second quality value against a second threshold; and
logically combining the first binary with the second binary result.

11. The method according to claim 10, in which the first threshold is not identical to the second threshold.

12. The method according to claim 9, in which combining the first quality value with the second quality value comprises:
multiplying the first quality value with a first weighting value to achieve a first weighted quality value;
multiplying the second quality value with at least a second weighting value to achieve a second weighted quality value; and
adding the first weighted quality value to the second weighted quality value.

13. The method according to claim 12, in which the second weighted quality value is achieved by multiplying the second quality value with the second weighting value and a further weighting value, in which the further weighting value is derived from one of a power difference between the first and second radio channels and a quality difference between the first and second radio channels.

14. The method according to claim 13, in which the method is performed by a user equipment operating in a UTRAN system, and the said one of power difference or quality difference is derived from at least one parameter received at the user equipment from a network node of the UTRAN system.

15. The method according to claim 9, in which testing whether the first radio channel is synchronized comprises comparing the combined first and second quality values against a signal quality threshold;
in which the first quality value is for power control bits received on the first channel which is a DPCCH or a F-DPCH, the second quality value is for the precoding information received on the second channel which is a downlink PCICH, and the precoding information represents antenna beamforming weights.

16. A computer readable memory storing a computer program comprising:
code for determining a first quality value for a first radio channel and a second quality value for a second radio channel, in which the second radio channel carries precoding information; and
code for testing whether the first radio channel is synchronized by combining the first quality value with the second quality value.

17. The computer readable memory according to claim 16, in which the code for testing operates to combine the first quality value with the second quality value by:
obtaining a first binary result by comparing the first quality value against a first threshold;
obtaining a second binary result by comparing the second quality value against a second threshold; and
logically combining the first binary with the second binary result.

18. The computer readable memory according to claim 16, in which the code for testing operates to combine the first quality value with the second quality value by:
multiplying the first quality value with a first weighting value to achieve a first weighted quality value;
multiplying the second quality value with at least a second weighting value to achieve a second weighted quality value; and
adding the first weighted quality value to the second weighted quality value.

19. The computer readable memory according to claim 18, in which the second weighted quality value is achieved by multiplying the second quality value with the second weighting value and a further weighting value, in which the further weighting value is derived from one of a power difference between the first and second radio channels and a quality difference between the first and second radio channels.

20. The computer readable memory according to claim 16, in which the code for testing operates to compare the combined first and second quality values against a signal quality threshold;
in which the first quality value is for power control bits received on the first channel which is a DPCCH or a F-DPCH, the second quality value is for the precoding information received on the second channel which is a downlink PCICH, and the precoding information represents antenna beamforming weights.
